(19) United States
(12) Patent Application Publication
(10) Pub. No.: US 2026/0169348 A1
(43) Pub. Date: Jun. 18, 2026

(54) PHOTONIC DEVICE WITH AN OPTICAL PARAMETRIC OSCILLATOR (OPO) FOR PROVIDING AN INTEGRATED MULTI-WAVELENGTH SOURCE

(71) Applicant: PINC Technologies Inc., Pasadena, CA (US)

(72) Inventors: Luis LEDEZMA, La Crescenta, CA (US); Alireza MARANDI, Pasadena, CA (US); Farzaneh AFSHINMANESH, Pasadena, CA (US)

(21) Appl. No.: 19/420,300

(22) Filed: Dec. 15, 2025

Related U.S. Application Data
(60) Provisional application No. 63/735,512, filed on Dec. 18, 2024.

(51) Int. Cl. G02F 1/35; G02B 6/293; G02F 1/39; H04B 10/50; H04B 10/548

(52) U.S. Cl. CPC G02F 1/3507; G02B 6/29343; G02F 1/3503; G02F 1/392; H04B 10/506; H04B 10/548; G02F 2203/69

(57) ABSTRACT

A photonic device is provided that includes a photonic chip with a χ⁽²⁾ optical parametric oscillator (OPO) configured to generate several output wavelengths simultaneously in response to a single laser pump. The photonic device may be configured to generate multiple laser wavelengths simultaneously for use as carriers for communication systems. In some aspects, the photonic device is configured to integrate data modulation into each carrier within the same photonic chip. In some aspects, the photonic device includes a chip with a set of OPOs, each of which is configured to generate one or more wavelength channels in response to one or more pump lasers, with the pump laser(s) configured in the form of a monolithic laser array or a single laser followed by an N-way splitter on the same chip. Method and device examples are described herein.

### CROSS-REFERENCE TO RELATED APPLICATIONS

This application claims priority under 35 U.S.C. § 119 to U.S. Provisional Application No. 63/735,512 , filed on Dec. 18, 2024, entitled, “PHOTONIC DEVICE WITH AN OPTICAL PARAMETRIC OSCILLATOR (OPO) FOR PROVIDING AN INTEGRATED MULTI-WAVELENGTH SOURCE,” the entire contents of which is incorporated herein by reference as if fully set forth below in its entirety and for all applicable purposes.

### FIELD

The subject matter described herein relates to photonic devices. More particularly, the subject matter relates, in some examples, to nonlinear photonic chips.

### INTRODUCTION

Wavelength division multiplexing, used in telecommunication and data center communication systems, high performance computing, optical I/O, and hardware for AI, increasingly requires higher bandwidth, and correspondingly, an increasing large number of carrier wavelengths on which to modulate the data. In the prior art, several carriers are generated either by combining several individual lasers or by the inefficient process of four-wave mixing to generate a frequency comb.

Aspects disclosed herein relate to generating multiple laser wavelengths simultaneously on a photonic chip that can be used as carriers for communication systems. The disclosed devices address shortcomings of the prior art by using a single laser source to pump an efficient multimode optical parametric oscillator to generate all desired wavelengths simultaneously while consuming less power. Aspects of the disclosure also relate to integrating data modulation into each carrier within the same photonic chip. Still other aspects relate to photonic devices that employ multiple pump lasers and multiple optical parametric oscillators.

### SUMMARY

The following presents a simplified summary of some aspects of the disclosure to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present various concepts of some aspects of the disclosure in a simplified form as a prelude to the more detailed description that is presented later.

One aspect of the disclosure provides a photonic device that includes a photonic integrated circuit with a χ⁽²⁾ optical parametric oscillator (OPO) on a chip configured to generate several output wavelengths simultaneously in response to a single laser pump, wherein the circuit is configurable to provide a desired uniform or non-uniform spacing of the output wavelengths. In some aspects, the laser pump is a semiconductor laser that can be either edged-coupled or surface-coupled to the chip. The laser pump may be a fiber-coupled laser. The photonic chip may further include a means for modulating each individual wavelength. The means for modulating may include a de-multiplexer configured to separate the individual wavelengths followed by a bank of modulators configured to modulate each wavelength. The device may also include a multiplexer configured to combine all the modulated wavelengths into a single output. The means for modulating may include a cascade of micro-ring resonators, each configured to modulate a specific wavelength.

In some aspects, a wavelength translator is provided, which is configured to shift the output wavelengths to shorter or longer wavelengths, including visible wavelengths. In some aspects, the output wavelengths and their separation can be configured by adjusting the OPO resonator geometry. In some aspects, the output wavelengths and their separation can be configured by using wavelength dependent feedback to create the OPO resonator. In some aspects, the wavelength dependent feedback is achieved by using a linear OPO resonator with Bragg mirrors having discrete reflectivity peaks. In some aspects, the wavelength dependent feedback is achieved by using grating assisted directional couplers in a racetrack OPO resonator. In some aspects, the wavelength dependent feedback is achieved by the addition of a micro-ring resonator inside the OPO resonator. In some aspects, the wavelength dependent feedback is achieved by the addition of a Mach-Zehnder interferometer inside the OPO resonator. In some aspects, the device is configured so that the χ⁽²⁾ effect is an effective χ⁽²⁾ resulting from the intrinsic χ⁽²⁾ of the material, e.g. from an applied electric field, a photogalvanic effect, or a photoconductive effect. In some aspects, the OPO includes an OPO resonator, and the output wavelengths and their separation are configurable by adjusting the geometry of the OPO resonator by, for example, adjusting the dispersion in the OPO resonator or adjusting the phase matching condition in the OPO for multiple wavelengths.

Another aspect of the disclosure provides a method for use with a photonic device. The method includes generating several output wavelengths simultaneously in response to a single laser pump using a photonic integrated circuit with a χ⁽²⁾ optical parametric oscillator (OPO) on a chip, wherein the circuit is configurable to provide a desired uniform or non-uniform spacing of the output wavelengths. The method may further include modulating each individual wavelength, wherein modulating each individual wavelength comprises using a de-multiplexer to separate the individual wavelengths followed by a bank of modulators configured to modulate each wavelength.

Yet another aspect of the disclosure provides a photonic device that includes a chip with a plurality of OPOs, each of which is configured to generate one or more wavelength channels, in response to one or more pump lasers and wherein the pump laser can be in the form of a monolithic laser array or in the form of a single laser followed by an N-way splitter on the same chip. In some aspects, the multiple OPOs share a single input reflector, a single optical parametric amplifier (OPA), and a single pump laser where each OPO output is independently provided by using a de-multiplexer followed by individual reflectors, one for each of the desired wavelength channels. In some aspects, the multiple OPOs share a single output reflector through a multiplexer and where each OPO has an individual input reflector and OPA.

### BRIEF DESCRIPTION OF THE DRAWINGS

FIG. 1 is a schematic block diagram illustrating an exemplary multi-wavelength output source configured in accordance with the prior art having several independent lasers.

FIG. 2 is a block diagram of an exemplary embodiment of a photonic device configured as an integrated multi-wavelength source within a multimode optical parametric oscillator (OPO), in accordance with some aspects of the disclosure.

FIG. 3 is a block diagram of an exemplary embodiment of a photonic device configured for use with data communications, in accordance with some aspects of the disclosure, wherein the device includes a single laser and a demultiplexer.

FIG. 4 is a block diagram of another exemplary embodiment of a photonic device with a multimode OPO, with the device configured for use with data communications, in accordance with some aspects of the disclosure, wherein the device includes a single laser and an output fiber array instead of a demultiplexer.

FIG. 5 is a block diagram of another exemplary embodiment of a photonic device with a multimode OPO, with the device configured for use with data communications, in accordance with some aspects of the disclosure, particularly illustrating exemplary laser wavelengths at different locations within the device.

FIG. 6 is a block diagram of an exemplary embodiment of a multimode OPO, in accordance with some aspects of the disclosure, which includes a racetrack resonator formed by directional couplers.

FIG. 7 is a block diagram of another exemplary embodiment of a multimode OPO, in accordance with some aspects of the disclosure, which includes a linear resonator formed by Bragg mirrors.

FIG. 8 is a block diagram of yet another exemplary embodiment of a multimode OPO, in accordance with some aspects of the disclosure, which includes a linear resonator formed with grating assisted directional couplers.

FIG. 9 is a block diagram of another exemplary embodiment of a multimode OPO, in accordance with some aspects of the disclosure, which includes an intracavity ring resonator.

FIG. 10 is a block diagram of another exemplary embodiment of a multimode OPO, in accordance with some aspects of the disclosure, which includes an intracavity Mach-Zehnder interferometer.

FIG. 11 is a block diagram of an exemplary embodiment of a photonic device with a laser bar and a set of multimode OPOs, in accordance with some aspects of the disclosure.

FIG. 12 is a block diagram of an exemplary embodiment of a photonic device with a laser bar and a wideband multimode OPO, in accordance with some aspects of the disclosure, wherein demultiplexing is performed inside the OPO cavity.

FIG. 13 is a block diagram of an exemplary embodiment of a photonic device with a laser bar, a set of OPOs, and a wideband reflector, in accordance with some aspects of the disclosure.

FIG. 14 illustrate multiplexing/demultiplexing grating architectures, in accordance with the prior art, which may be integrated into a photonic device with a multimode OPO.

FIG. 15 is a block diagram of an exemplary embodiment of a photonic device with micro-ring-based drop filters, in accordance with some aspects of the disclosure.

FIG. 16 is a block diagram of an exemplary embodiment of a photonic device configured for flexible wavelength generation, in accordance with some aspects of the disclosure.

FIG. 17 is a graph illustrating experimental measurement results of an exemplary embodiment of a multimode OPO, in accordance with some aspects of the disclosure.

FIG. 18 is a graph illustrating experimental measurement results of an exemplary embodiment of a multimode OPO, in accordance with some aspects of the disclosure.

FIG. 19 illustrates an optical device including an optical parametric oscillator on thin-film lithium niobate integrated with a DBR laser, which can be controlled to operate as a tunable source or a multi-wavelength source, in accordance with some aspects of the disclosure.

FIG. 20 illustrates fine and course tuning results obtained using the device of FIG. 19, in accordance with some aspects of the disclosure.

FIG. 21 illustrates output power and stability results obtained using the device of FIG. 19, in accordance with some aspects of the disclosure.

### DETAILED DESCRIPTION

In the following detailed description, reference is made to the accompanying drawings, which form a part thereof. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

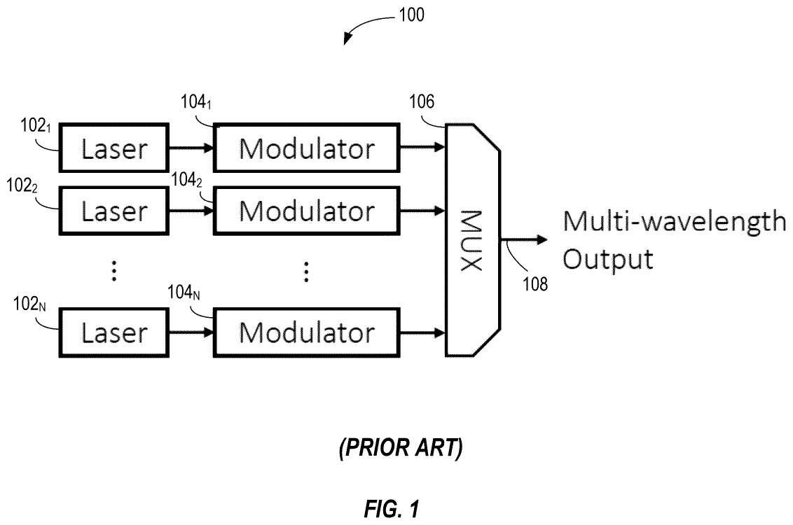

FIG. 1 illustrates an exemplary multi-wavelength output source device 100 configured in accordance with the prior art having several independent lasers. Briefly, the device 100 includes N lasers 102₁ through 102_{N} and N modulators 104₁ through 104_{N}, which feed into a multiplexer (MUX) 106 to provide a multiple wavelength output 108. With such a device, several carriers are generated by combining several individual lasers. Alternatively, several carriers may be generated by the inefficient process of four-wave mixing to generate a frequency comb.

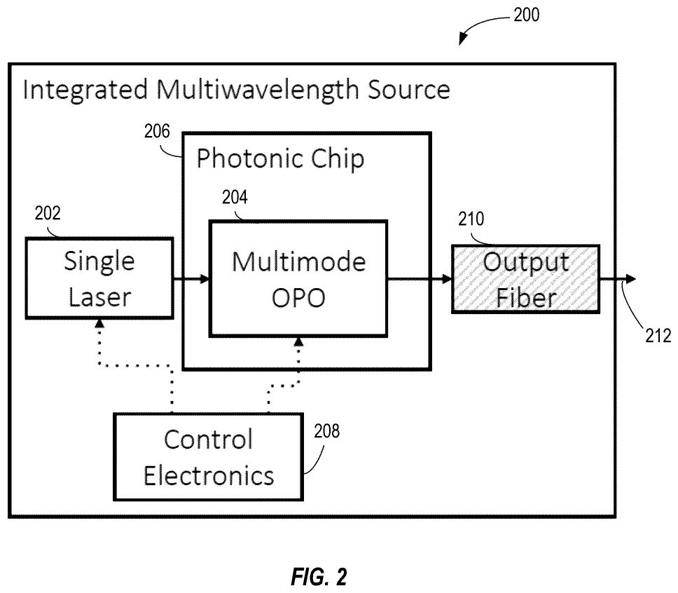

FIG. 2 is a block diagram of an exemplary embodiment of a photonic device 200 configured as an integrated multi-wavelength source, in accordance with some aspects of the disclosure. In this example, a single laser is integrated with a multimode optical parametric oscillator (OPO) to produce a multitude (plurality) of wavelengths. An output optical fiber can be optionally included as part of the package. In the example of FIG. 2, the device 200 includes a single laser 202 that feeds into a multimode OPO 204 of a photonic chip 206. Control electronics 208 is configured to control both the single laser and the multimode OPO. The output of the multimode OPO feeds into an output fiber 210, which provides an output signal 212.

Herein, the term OPO refers to a χ⁽²⁾ OPO, which is an optical device configured to generate a tunable coherent light by converting a single input laser beam (referred to as the “pump”) into two output beams of lower frequencies (usually referred to as the “signal” and “idler” beams) through a nonlinear optical process based on a quadratic nonlinear susceptibility (χ⁽²⁾) within a resonant cavity. This allows for a wide range of wavelengths to be produced depending on the configuration and tuning mechanism used. A χ⁽²⁾ OPO can provide a versatile light source for applications such as spectroscopy, microscopy, and remote sensing.

Herein, a “multimode OPO” is a type of OPO that can simultaneously generate multiple optical frequencies (modes) within its output, thus enabling the generation of a broader range of wavelengths as compared to a single-mode OPO (which usually generates only one signal and idler pair at a time). The multimode operation may be achieved by using, e.g., a nonlinear waveguide with wideband parametric gain and a cavity design that supports multiple resonant modes within the parametric gain bandwidth.

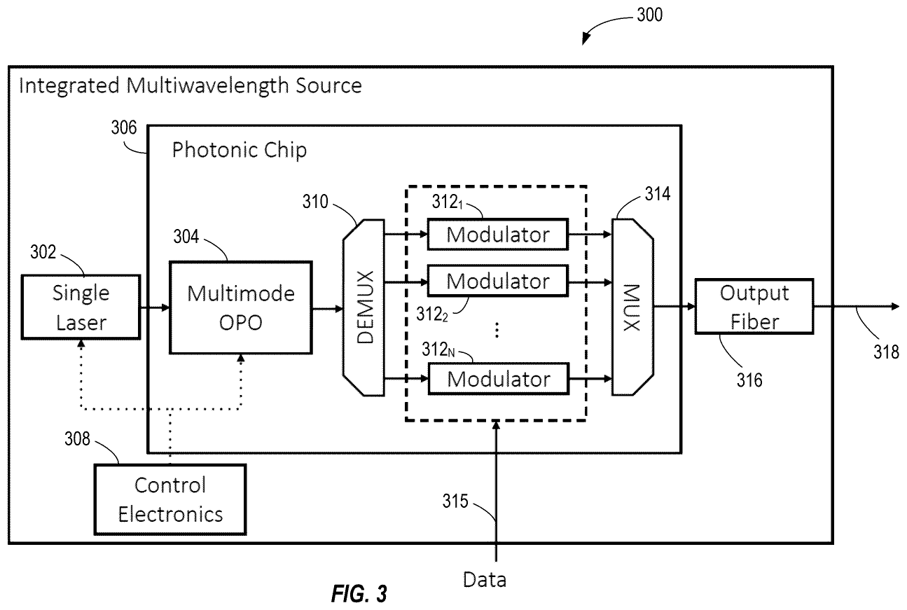

FIG. 3 is a block diagram of an exemplary embodiment of a photonic device 300 with a multimode OPO, with the device configured as an integrated multi-wavelength source for use with data communications, in accordance with some aspects of the disclosure. In this example, a single laser is integrated with a multimode OPO to produce a multitude (plurality) of wavelengths, which are further separated and modulated on the same photonic chip. The output can be recombined on the same photonic chip to produce a singular output. In the example of FIG. 3, the device 300 includes a single laser 302 that feeds into a multimode OPO 304 of a photonic chip 306. Control electronics 308 is configured to control both the single laser and the multimode OPO. The output of the multimode OPO feeds into a demultiplexer (DEMUX) 310, which provides multiple (N) signals that are fed into a set of N modulators 312₁-312_{N} whose output is fed into a multiplexer (MUX) 314. A data signal 315 is applied to the modulators to modulate the multiple signals that pass through the modulators so the signals applied to the MUX 314 are thus modulated by the data. The output of the MUX 314 is fed into an output fiber 316, which provides an output signal 318.

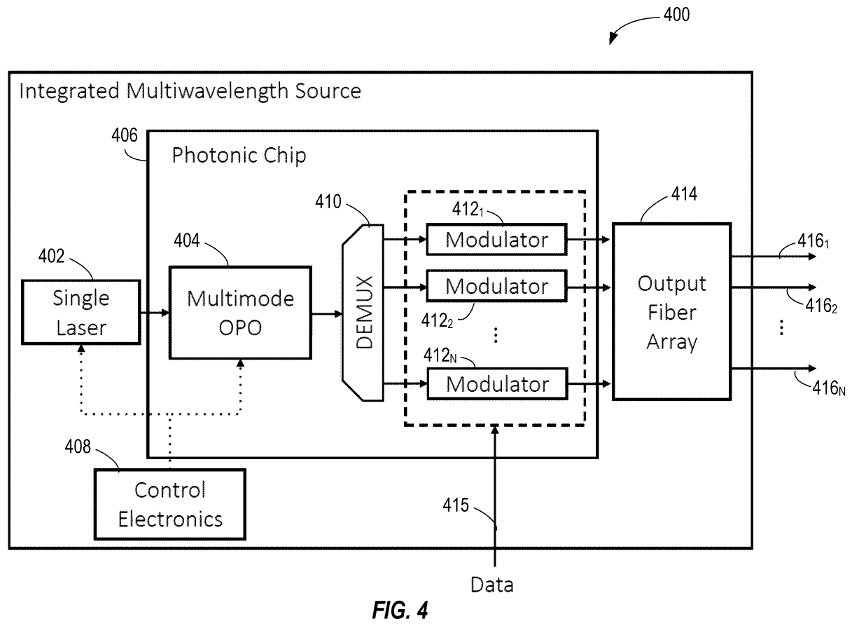

FIG. 4 is a block diagram of another exemplary embodiment of a photonic device 400 with a multimode OPO, with the device configured as an integrated multi-wavelength source for use with data communications, in accordance with some aspects of the disclosure. FIG. 4 shows that the multi-wavelength output can be directly coupled into a fiber array without on-chip combining (e.g., without an on-chip multiplexer). This may be useful in “slow and wide” architectures where each fiber carries a separate data channel. In the example of FIG. 4, the device 400 includes a single laser 402 that feeds into a multimode OPO 404 of a photonic chip 406. Control electronics 408 again controls both the single laser and the multimode OPO. The output of the multimode OPO 404 feeds into a demultiplexer (DEMUX) 410 which provides multiple (N) signals fed into a set of N modulators 412₁-412_{N} whose output is fed into an output fiber array 414. A data signal 415 is applied to the modulators to modulate the multiple signals that pass through the modulators so the N signals applied to the fiber array 414 are thus modulated by the data. The N outputs of the fiber array 414 provide a set of N output signals 416₁-416_{N}.

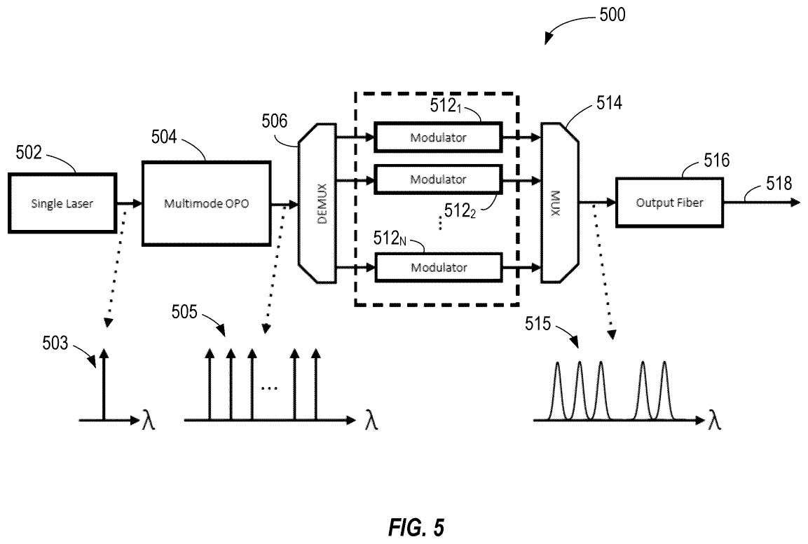

FIG. 5 is a block diagram of another exemplary embodiment of a photonic device 500 with a multimode OPO, in accordance with some aspects of the disclosure. FIG. 5 shows exemplary laser wavelengths at different locations within the device. As shown, a single discrete wavelength optical signal from a single laser is converted into a set of discrete wavelength optical signals by the multimode OPO, which are then converted into a set of modulated (non-discrete) optical signals for output into an output fiber. In the example of FIG. 5, device 500 includes a laser 502 that generates a single discrete optical signal 503 that feeds into a multimode OPO 504, which generates a set of discrete wavelength optical signals 505 that are input into demultiplexer 506. The N outputs of the demultiplexer are fed into a set of N modulators 512₁-512_{N} whose output is fed into a multiplexer 514. The output of the multiplexer provides a set of non-discreet modulated optical signals 515, which are fed into an output fiber 516 to provide the final output signal 518.

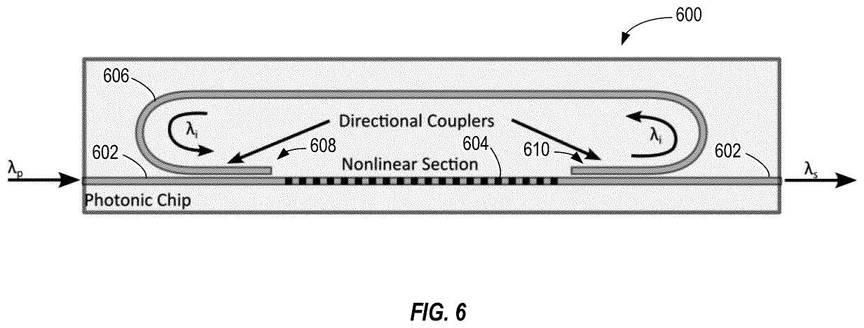

FIG. 6 is a block diagram of an exemplary embodiment of a multimode OPO device 600, in accordance with some aspects of the disclosure. In this example, the OPO is configured with racetrack resonator formed by directional couplers. The size of the resonator determines the free-spectral range between oscillating modes. The large bandwidth provided by the parametric nonlinear section can allow a large number of modes to oscillate. This bandwidth can be further designed and configured by dispersion engineering of the waveguide. In the example of FIG. 6, the device 600 receives an input signal having a wavelength λₚ into a waveguide 602, which includes a nonlinear section 604. The photonic chip 600 also includes a resonator waveguide 606 coupled to the waveguide 602 at opposing ends of the nonlinear section 604 via a pair of directional couplers 608 and 610. As shown, signals with a wavelength of λᵢ propagate within the resonator waveguide 606. The final output of waveguide 602 is an output signal with a wavelength of λₛ.

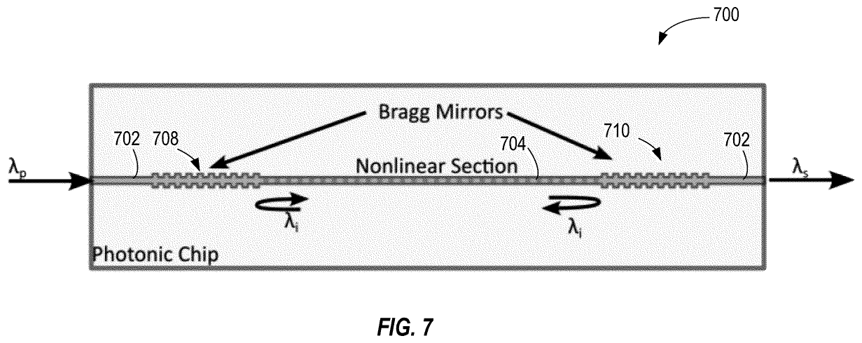

FIG. 7 is a block diagram of another exemplary embodiment of a multimode OPO device 700, in accordance with some aspects of the disclosure. In this example, the OPO is configured with a linear resonator formed by Bragg mirrors. The smaller size of the resonator produces a larger free-spectral range compared to the racetrack resonator of FIG. 6. Furthermore, the Bragg mirrors can be designed and configured to provide high reflectivity in a discrete number of peaks matching the targeted output wavelengths. In the example of FIG. 7, the device 700 or receives an input signal having a wavelength λₚ into a waveguide 702, which includes a nonlinear section 704. The photonic chip 700 also includes Bragg mirrors 708 and 710 at opposing ends of the nonlinear section 704. As shown, signals with a wavelength of λᵢ reflect back and forth within the nonlinear section 704. The final output of waveguide 707 is an output signal with a wavelength of λₛ.

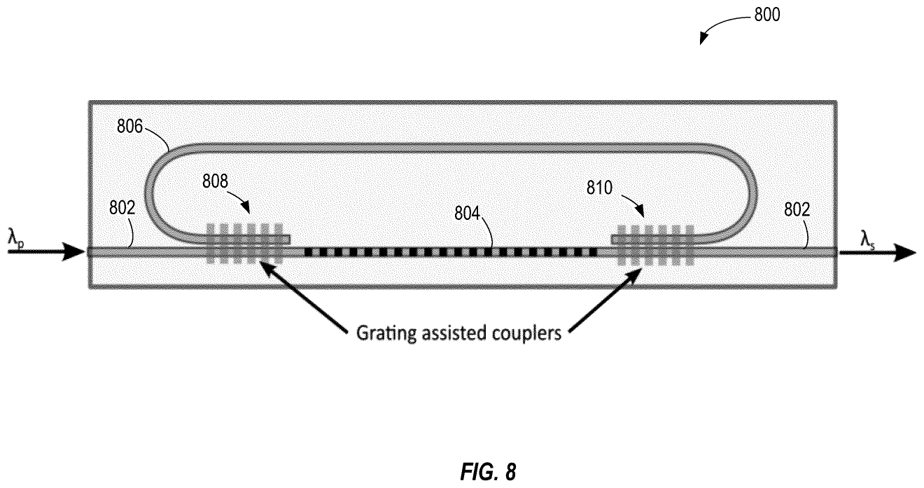

FIG. 8 is a block diagram of yet another exemplary embodiment of a multimode OPO device 800, in accordance with some aspects of the disclosure. In this example, the OPO is configured with a racetrack resonator formed by grating assisted directional couplers. The gratings can be designed and configured to provide high coupling in a discrete number of peaks matching the targeted output wavelengths. In the example of FIG. 8, the device 800 receives an input signal having a wavelength λₚ into a waveguide 802, which includes a nonlinear section 804. The photonic chip 800 also includes a resonator waveguide 806 coupled to the waveguide 802 at its opposing ends of the nonlinear section 804 via a pair of grating assisted couplers 808 and 810. As in the photonic chip of FIG. 6, signals with a wavelength of λᵢ propagate within the resonator waveguide 806 of FIG. 8. The final output of waveguide 802 is an output signal with a wavelength of λₛ.

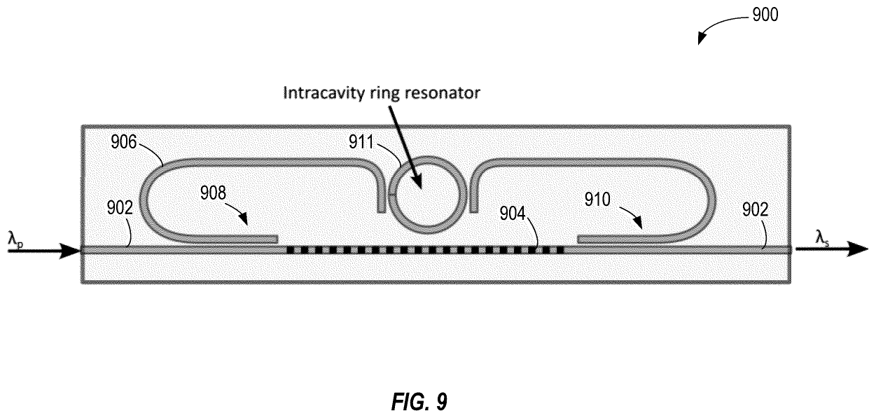

FIG. 9 is a block diagram of yet another exemplary embodiment of a multimode OPO device 900, in accordance with some aspects of the disclosure. In this example, the racetrack OPO is configured with an additional intracavity ring resonator. The oscillating modes can be designed or controlled by configuring the overlap between the resonances of the racetrack and ring resonators. In the example of FIG. 9, the device 900 receives an input signal having a wavelength λₚ into a waveguide 902, which includes a nonlinear section 904. The photonic chip 900 also includes a resonator waveguide 906 coupled to the waveguide 902 at opposing ends of the nonlinear section 904 via a pair of directional couplers 908 and 910. An intracavity ring resonator 911 is provided with opposing sides of the ring resonator 911 coupled to portions of the resonator waveguide 906 as shown via another pair of directional couplers. The final output of waveguide 902 is an output signal with a wavelength of λₛ.

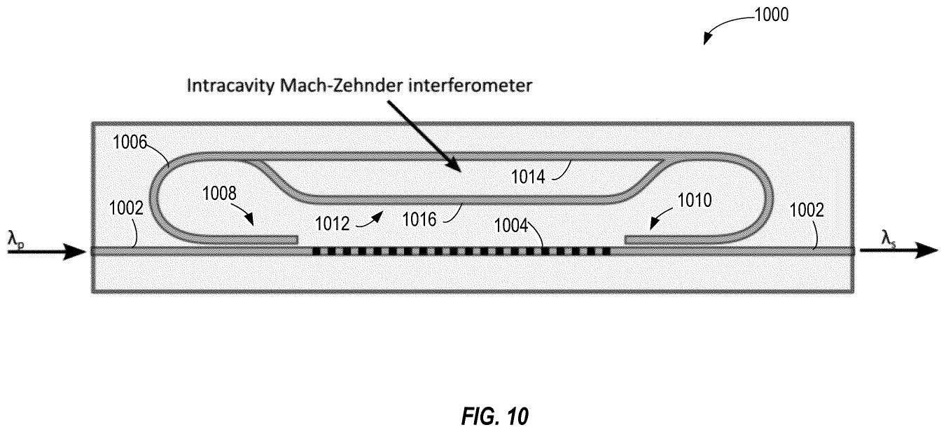

FIG. 10 is a block diagram of yet another exemplary embodiment of a multimode OPO device 1000, in accordance with some aspects of the disclosure. In this example, the racetrack OPO is configured with an additional intracavity Mach-Zehnder interferometer. The oscillating modes can be designed or controlled by configuring the overlap between the resonances of the racetrack and the interferometer passband. In the example of FIG. 10, the device 1000 receives an input signal having a wavelength λₚ into a waveguide 1002, which includes a nonlinear section 1004. The photonic chip 1000 also includes a resonator waveguide 1006 coupled to the waveguide 1002 at opposing ends of the nonlinear section 1004 via a pair of directional couplers 1008 and 1010. A portion of the resonator waveguide is configured as a Mach-Zehnder interferometer 1012, with the resonator waveguide split as shown into two sections of different lengths, 1014 and 1016. The final output of waveguide 1002 is an output signal with a wavelength of λₛ.

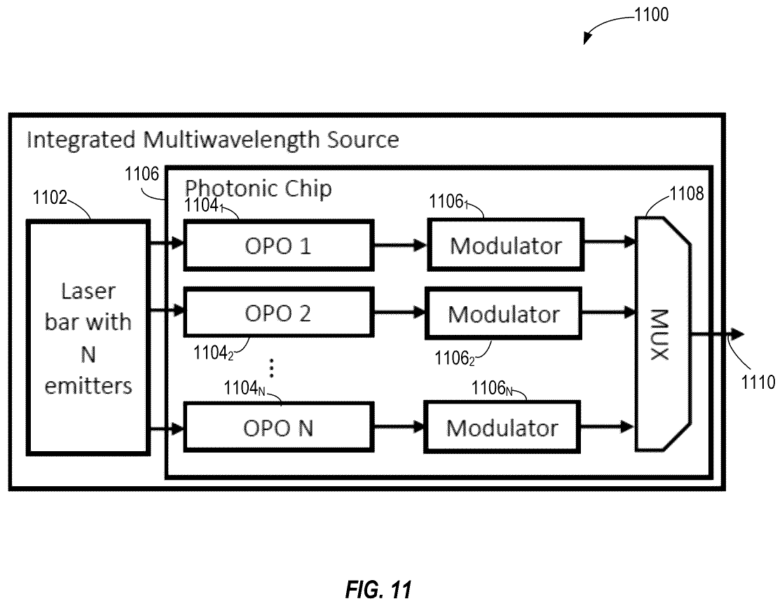

FIG. 11 is a block diagram of an exemplary embodiment of a photonic device 1100 with a set of multimode OPOs, in accordance with some aspects of the disclosure. In this example, several individual OPOs are included in the same photonic chip and are modulated independently before their outputs are combined in a multiplexer. Optionally, the pump laser bar can be replaced with a single laser and an on-chip N-way splitter. In the example of FIG. 11, the device 1100 includes a laser bar 1102 with N emitters that generates N optical signals that feed into a corresponding set of N multimode OPOs 1104₁-1104_{N}, which generate optical signals that are input into a corresponding set of N modulators 1106₁-1106_{N}. The outputs of the N modulators are fed into a multiplexer 1108, and the output of the multiplexer provides the final optical signal 1110.

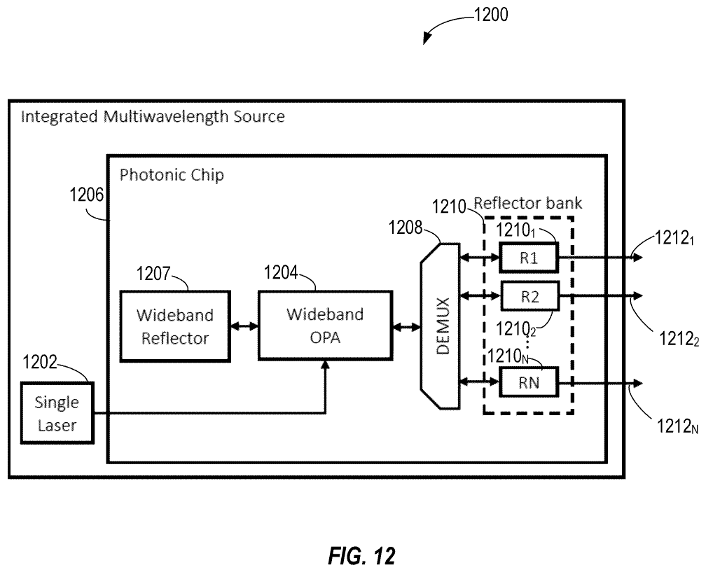

FIG. 12 is a block diagram of an exemplary embodiment of a photonic device 1200 configured as an integrated multiwavelength source with a wideband multimode OPO, in accordance with some aspects of the disclosure. In this example, the demultiplexing is performed inside the OPO cavity, with each arm of the de-multiplexer proving a reflective component at the appropriate wavelength. The rest of the OPO resonator may consist of a wideband OPA and reflector working over the entire bandwidth. Optionally, the OPA can be configured to provide gain only at the desired wavelengths. In the example of FIG. 12, the device 1200 includes a single laser 1202 that generates an optical signal that is fed into a wideband OPA 1204 of a photonic chip 1206, which also includes a wideband reflector 1207 coupled to the wideband OPA 1204. The wideband OPO circuits is the combination of the OPA 1204, the wideband reflector 1207, the demultiplexer 1208, and the individual reflectors 1210. The OPO generates optical signals that are input into demultiplexer 1208. The N outputs of the demultiplexer 1208 are fed into a reflector bank 1210 that includes a set of N individual reflectors 1210₁-1210_{N}. The output of the reflector bank 1210 provides a set of N output signals 1212₁-1212_{N}.

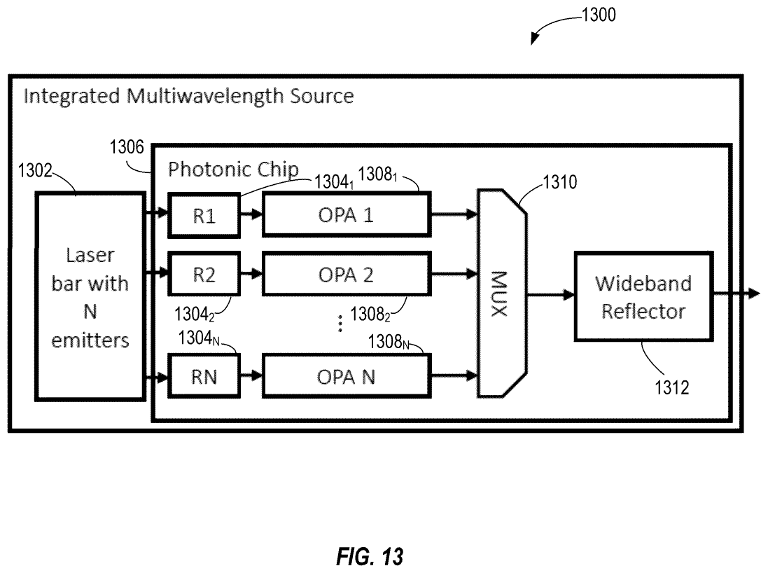

FIG. 13 is a block diagram of an exemplary embodiment of a photonic device 1300 configured as an integrated multiwavelength source with a set of multimode OPOs and a wideband reflector, in accordance with some aspects of the disclosure. In this example, several OPOs share a common output reflector/coupler, but have individual input reflectors and pump lasers in the form of a laser bar. Optionally, the pump laser bar can be replaced with a single laser and an on-chip N-way splitter. In the example of FIG. 13, the device 1300 includes a laser bar 1302 with N emitters that generates N optical signals that feed into a corresponding set of N reflectors R 1304₁-1304_{N} of a photonic chip 1306, which, in turn, feed into a set of N multimode OPOs 1308₁-1308_{N}, which output N optical signals into a multiplexer 1310. The output of the multiplexer 1310 is fed into a wideband reflector 1312, which provides the final optical signals.

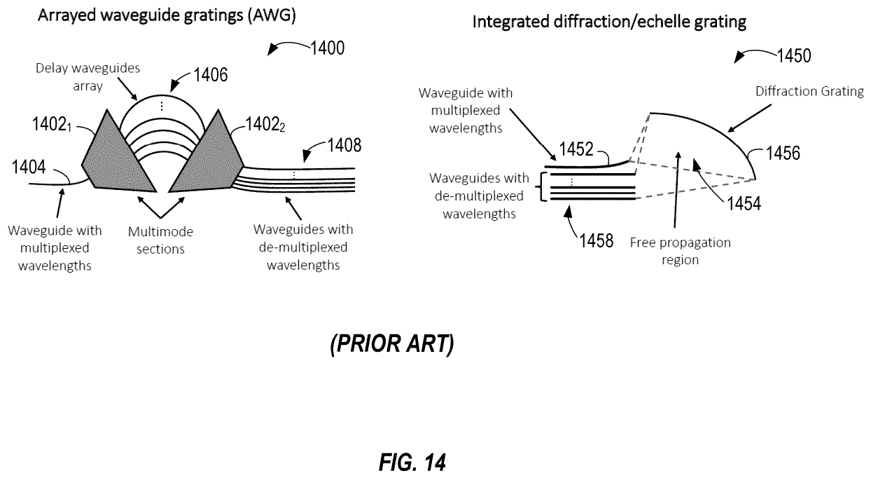

FIG. 14 illustrate a pair of multiplexing/demultiplexing (MUX/DEMUX) grating architectures, in accordance with the prior art, which may be integrated into a photonic device with a multimode OPO. The first architecture provides an arrayed waveguide grating (AWG) 1400 that includes a pair of multimode sections 1402₁ and 1404₂. The multimode section 1402₁ is coupled to a waveguide 1404 with multiplexed wavelengths. An array 1406 of delay waveguides couple the first multimode section 1402₁ to the second multimode section 1404₂, each providing a different amount of delay. A set of output waveguides 1408 are coupled to the second multimode section 1404₂ to output a set of de-multiplexed wavelengths. Alternatively, optical signals could be sent through the device in the opposite direction. The second architecture of FIG. 14 provides an integrated diffraction/echelle grating 1450 that includes a waveguide 1452 with multiplexed wavelengths that emits the multiplexed wavelengths into a free space propagation region 1454 toward a diffraction grating 1456. The diffraction grating 1456 reflects the signals back through the free space propagation region to a set of waveguides 1458 as de-multiplexed wavelengths. Alternatively, optical signals could be sent through the device in the opposite direction. The various multiplexers and demultiplexers shown in FIGS. 2-13 may be configured, where appropriate, using the MUX/DEMUX devices of FIG. 14.

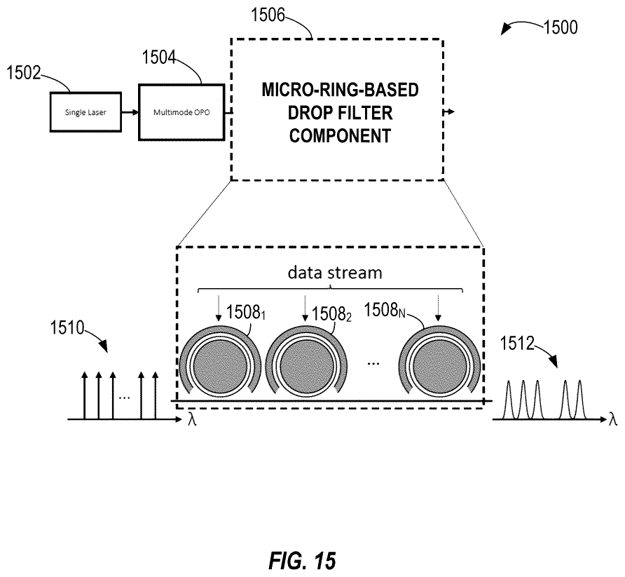

FIG. 15 is a block diagram of an exemplary embodiment of a photonic device 1500 with micro-ring-based drop filters, in accordance with some aspects of the disclosure. In this example, a cascade of ring-resonators is provided to directly modulate each individual wavelength without using explicit demultiplexers. The rings may be micro-rings, i.e. devices having sizes on the order of microns (e.g., from a few microns to tens of microns). More specifically, the photonic 1500 includes a single laser 1502 that feeds into a multimode OPO 1504. The output of the multimode OPO feeds into a micro-ring-based drop filter component 1506. A lower portion of FIG. 15 illustrates the internal components of the micro-ring-based drop filter component 1506. As shown, the filter component 1506 includes a cascade of N ring resonators 1508₁-1508_{N}. A set of discrete wavelength optical signals 1510 are output from the multimode OPO 1504 into the filter component 1506 and processed as a data steam to generate and output a final non-discrete modulated optical signal 1512.

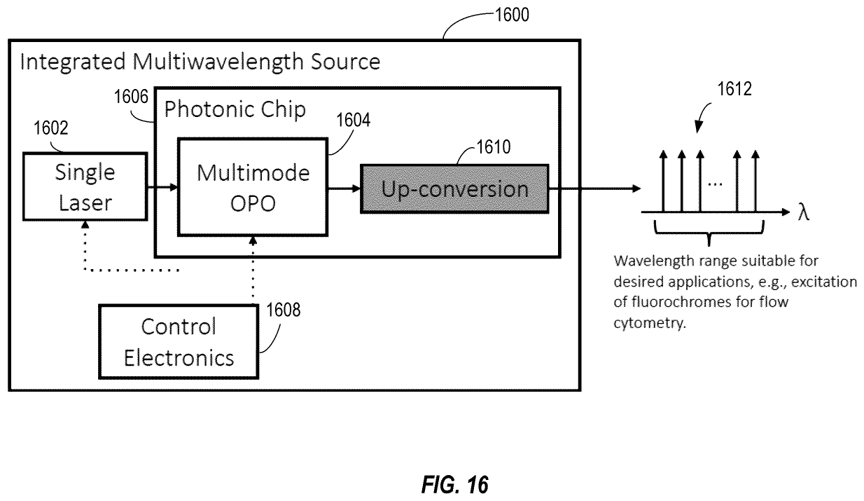

FIG. 16 is a block diagram of an exemplary embodiment of a photonic device 1600 configured as an integrated multiwavelength source for flexible wavelength generation, in accordance with some aspects of the disclosure. In this example, the nonlinear platform enables the on-chip translation of the generated wavelengths to other desired wavelength ranges. More specifically, the device 1600 includes a single laser 1602 that feeds into a multimode OPO 1604 of a photonic chip 1606. Control electronics 1608 controls both the single laser and the multimode OPO. The output of the multimode OPO feeds into an up-conversion component 1610, which provides an output signal 1612, which includes a wavelength range suitable for various applications such as excitation of fluorochromes for flow cytometry.

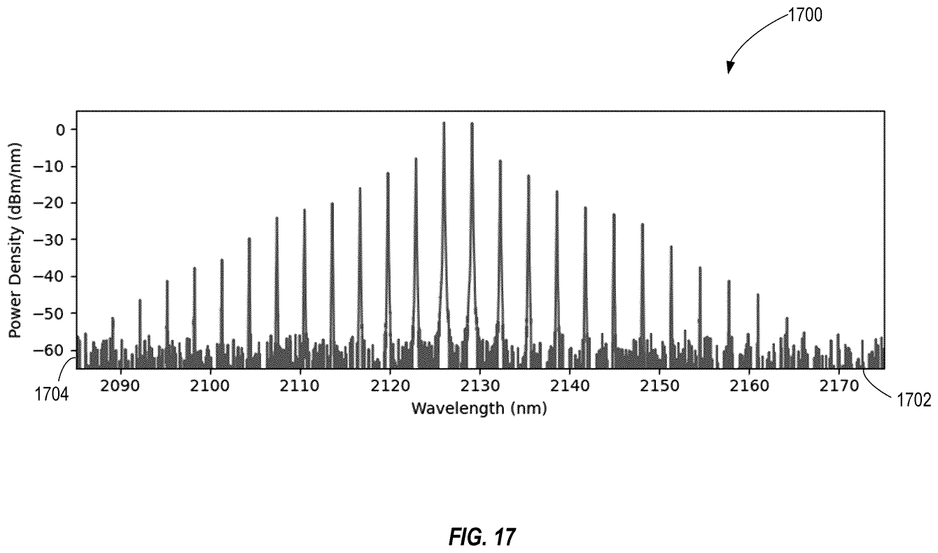

FIG. 17 is a graph 1700 illustrating experimental measurement results of an exemplary embodiment of a multimode OPO, in accordance with some aspects of the disclosure. The x-axis 1702 of the graph represent wavelength in nanometers (nm). The y-axis 1704 of the graph represent power density in dBm/nm. In this example, the intramode spacing of approximately 3.4 nm (approx. 230 GHz) was designed to be much larger than the 6 GHz resonator free-spectral range.

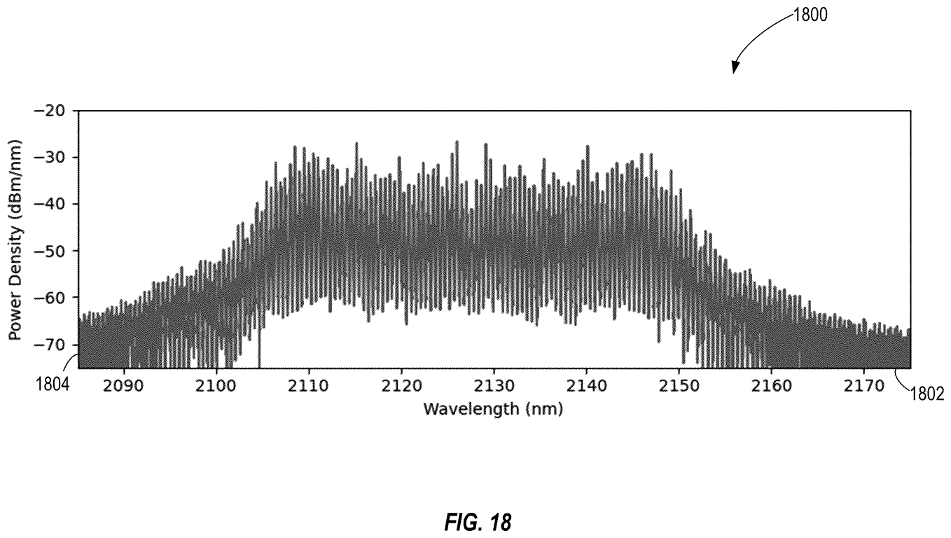

FIG. 18 is a graph 1800 illustrating experimental measurement results of an exemplary embodiment of a multimode OPO, in accordance with some aspects of the disclosure. The x-axis 1802 of the graph again represents wavelength in nm. The y-axis 1804 again represents power density in dBm/nm. In this example, the intramode spacing was designed to be similar to the 6 GHz resonator free-spectral range.

The multi-wavelength spectra illustrated in FIGS. 17 and 18 were obtained by adjusting the pump current, temperature, and the electrooptical (EO) drive features of the photonic device. More specifically, this was done using a hybrid integration combining an on-chip OPO in thin-film lithium niobate with a commercially available laser diode. By combining the advantages of both technologies, a device was created that can operate as a tunable light source and a multi-wavelength source that is both compact and efficient. Coarse tuning is achieved by adjusting the phase-matching condition with temperature. Continuous fine tuning is possible by combining electro-tuning of the OPO resonator with tuning of the pump laser. Importantly, the pump wavelength should be tuned over a range of the order of the OPO free-spectral range (˜10 GHz), which represents a modest tuning easily achievable by most diode lasers. By optimizing the output fiber coupling to the chip, one can measure output power levels exceeding 1 mW into a single-mode fiber and confirm stable operation over several hours without mode hops. The combination of wide tuning, mW-level of on-fiber power, and mode-hop free stability represents a critical step towards a fully integrated and cost-effective source that can directly be applied to a large range of commercial applications from high-resolution spectroscopy to portable sensors for real-time environmental and medical monitoring as well as optical communication links.

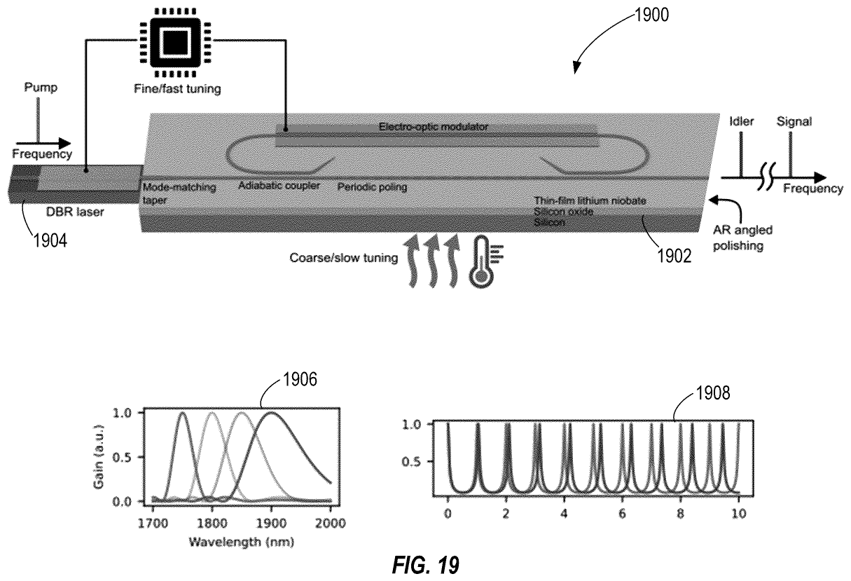

FIG. 19 illustrates the above-described hybrid optical device 1900 that includes an optical parametric oscillator on thin-film lithium niobate 1902 that is integrated with a DBR laser 1904, and which can be controlled to operate as a tunable source or a multi-wavelength source. The OPO chip can be anti-reflection (AR) angle-polished, either vertically and/or horizontally to minimize back reflection to the integrated laser. Graph 1906 shows the parametric gain spectra for different temperatures (with the different temperatures shown via different shades of gray in the graph lines). Graph 1908 shows the tuning of the OPO resonator modes with EO tuning (again with different applied voltages to the modulator shown via different shades of gray in the graph lines).

The overall tuning involves fine tuning the modes with DBR and EO and coarse turning QPM with the OPO temperature. That is, fine tuning may be based on a combination of pump tuning with electro-optic tuning. Changing just one of these variables produces tuning that hops by a free-spectral range due to the vernier effect between the signal and idler resonances (as shown in FIG. 19). By using both mechanisms simultaneously, one can avoid these hops. For instance, as the pump frequency increases, the signal/idler pair (or resonances) would slide away from each other in opposite directions (due to conservation of energy), but they can be brought back into resonance by decreasing the total delay of the resonator.

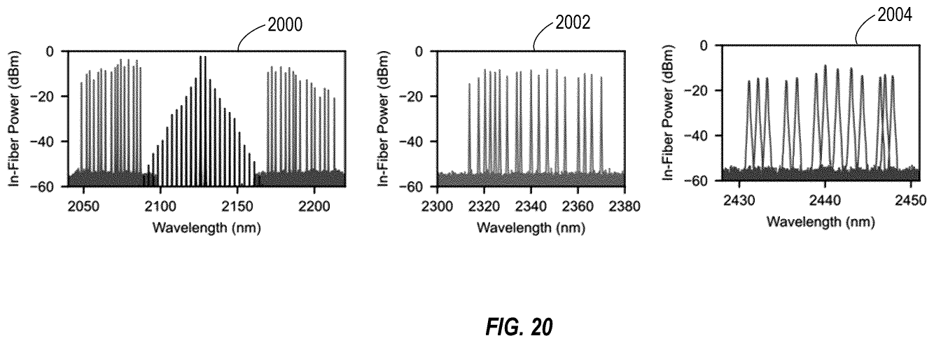

FIG. 20 illustrates exemplary fine and course tuning results and confirms that the OPO output band can be adjusted by changing the chip temperature. More specifically, FIG. 20 shows signals and idlers in three different bands. Spectra 2000 shows a first band from about 2050 nm to 2250 nm. Spectra 2002 shows a second band from about 2300 nm to 2380 nm. Spectra 2004 shows a third band from about 2400 nm to 2450 nm. Note that spectra 2000 further illustrates the tunable operation, as well as the multi-wavelength operation with proper control of the pump and OPO. The triangular shape spectrum spanning from ˜2090 nm to ˜2170 nm in 2000 is an instantaneous multi-wavelength spectra obtained by the OPO while operating at degeneracy, i.e. pump wavelength being ˜1064 nm, (this spectra is the same as what appears in 1700) while the peaks outside that band in 2000 correspond to the overlaid single-wavelength tunable spectra. Similarly, 2002 and 2004 correspond to tunable spectra of overlaid single-wavelength outputs of the OPO. Proper tuning of temperature, laser current, and EO voltage can be used to switch operation of the device from tunable source to multi-wavelength source.

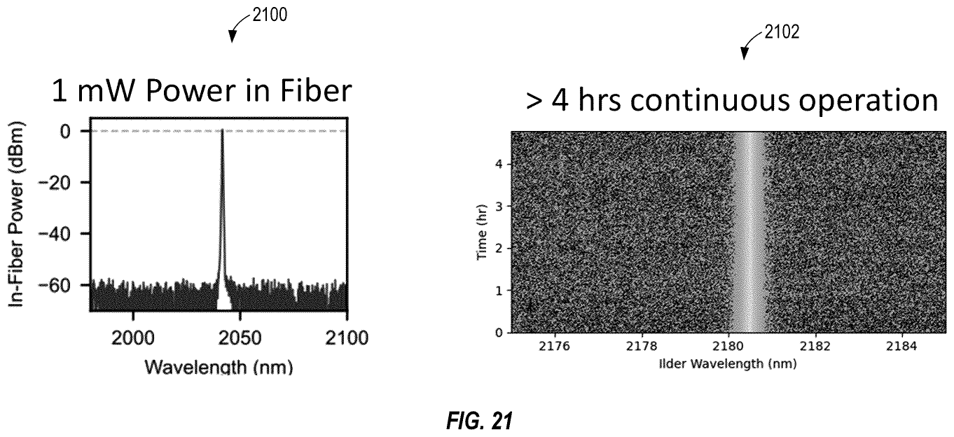

FIG. 21 illustrates output power and stability results and confirms that stable operation of the OPO can be achieved in a single-mode regime with ˜1 mW of power in the output single-mode fiber for hours. Similar operation has been observed in the multi-wavelength range. More specifically, spectra 2100 shows in fiber power at about 2050 nm. Spectra 2102 shows the idler wavelength at around 2180 nm after four hours of continuous operations. Both spectra shown strong stability at precise wavelengths.

The examples set forth herein are provided to illustrate certain concepts of the disclosure. The apparatus, devices, or components illustrated above may be configured to perform one or more of the methods, features, or steps described herein. Those of ordinary skill in the art will comprehend that these are merely illustrative in nature, and other examples may fall within the scope of the disclosure and the appended claims. Based on the teachings herein those skilled in the art should appreciate that an aspect disclosed herein may be implemented independently of other aspects and that two or more of these aspects may be combined in various ways. For example, an apparatus may be implemented or a method may be practiced using any number of the aspects set forth herein. In some cases, such an apparatus may be implemented or such a method may be practiced using other structures or functionalities in addition to or other than one or more of the aspects set forth herein.

The word “exemplary” is used herein to mean “serving as an example, instance, or illustration.” Any aspect described herein as “exemplary” is not necessarily to be construed as preferred or advantageous over other aspects. Likewise, the term “aspects” does not require that all aspects include the discussed feature, advantage, or mode of operation. While the above descriptions contain many specific embodiments of the invention, these should not be construed as limitations on the scope of the invention, but rather as examples of specific embodiments thereof. Accordingly, the scope of the invention should be determined not by the embodiments illustrated, but by the appended claims and their equivalents. Moreover, reference throughout this specification to “one embodiment,” “an embodiment,” “in one aspect,” or similar language means that a particular feature, structure, or characteristic described in connection with the embodiment is included in at least one embodiment of the present disclosure. Thus, appearances of the phrases “in one embodiment,” “in an embodiment,” “in one aspect,” and similar language throughout this specification may, but do not necessarily, all refer to the same embodiment, but mean “one or more but not all embodiments” unless expressly specified otherwise.

If used herein, the term “determining” encompasses a wide variety of actions. For example, “determining” may include calculating, computing, processing, deriving, investigating, looking up (e.g., looking up in a table, a datastore, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The terminology used herein is for the purpose of describing particular aspects only and is not intended to be limiting of the aspects. As used herein, the singular forms “a,” “an” and “the” are intended to include the plural forms as well (i.e., one or more), unless the context clearly indicates otherwise. An enumerated listing of items does not imply that any or all of the items are mutually exclusive and/or mutually inclusive, unless expressly specified otherwise. It will be further understood that the terms “comprises,” “comprising,” “includes” “including,” “having,” and variations thereof when used herein mean “including but not limited to” unless expressly specified otherwise. That is, these terms may specify the presence of stated features, integers, steps, operations, elements, or components, but do not preclude the presence or addition of one or more other features, integers, steps, operations, elements, components, or groups thereof. Moreover, it is understood that the word “or” has the same meaning as the Boolean operator “OR,” that is, it encompasses the possibilities of “either” and “both” and is not limited to “exclusive or” (“XOR”), unless expressly stated otherwise. It is also understood that the symbol “/” between two adjacent words has the same meaning as “or” unless expressly stated otherwise. Moreover, phrases such as “connected to,” “coupled to” or “in communication with” are not limited to direct connections unless expressly stated otherwise.

Any reference to an element herein using a designation such as “first,” “second,” and so forth does not generally limit the quantity or order of those elements. Rather, these designations may be used herein as a convenient method of distinguishing between two or more elements or instances of an element. Thus, a reference to first and second elements does not mean that only two elements may be used there or that the first element must precede the second element in some manner. Also, unless stated otherwise a set of elements may include one or more elements. In addition, terminology of the form “at least one of A, B, or C” or “A, B, C, or any combination thereof” or “one or more of A, B, or C” used in the description or the claims means “A or B or C or any combination of these elements.” For example, this terminology may include A, or B, or C, or A and B, or A and C, or A and B and C, or 2A, or 2B, or 2C, or 2A and B, and so on. As a further example, “at least one of: A, B, or C” or “one or more of A, B, or C” is intended to cover A, B, C, A-B, A-C, B-C, and A-B-C, as well as multiples of the same members (e.g., any lists that include AA, BB, or CC). Likewise, “at least one of: A, B, and C” or “one or more of A, B, or C” is intended to cover A, B, C, A-B, A-C, B-C, and A-B-C, as well as multiples of the same members. Similarly, as used herein, a phrase referring to a list of items linked with “and/or” refers to any combination of the items. As an example, “A and/or B” is intended to cover A alone, B alone, or A and B together. As another example, “A, B and/or C” is intended to cover A alone, B alone, C alone, A and B together, A and C together, B and C together, or A, B, and C together.

What is claimed is:

1. A photonic device comprising a photonic integrated circuit with a χ⁽²⁾ optical parametric oscillator (OPO) on a chip configured to generate several output wavelengths simultaneously in response to a single laser pump, wherein the circuit is configurable to provide a desired uniform or non-uniform spacing of the output wavelengths.

2. The device of claim 1, wherein the laser pump is a semiconductor laser or a solid-state laser integrated to the chip as either edged-coupled or surface-coupled.

3. The device of claim 1, wherein the chip further comprises means for modulating one or a plurality of the output wavelengths.

4. The device of claim 3, wherein the means for modulating comprises a de-multiplexer configured to separate individual wavelengths followed by a bank of modulators configured to modulate each wavelength.

5. The device of claim 4, further comprising a multiplexer configured to combine all of a set of modulated wavelengths into a single output.

6. The device of claim 3, wherein the means for modulating comprises a cascade of micro-ring resonators, each configured to modulate a specific wavelength.

7. The device of claim 1, further comprising a wavelength translator configured to shift the output wavelengths to shorter or longer wavelengths, including visible wavelengths.

8. The device of claim 1, wherein the OPO includes an OPO resonator, and wherein output wavelengths and their separation are configurable by adjusting the geometry of the OPO resonator.

9. The device of claim 1, wherein the OPO includes an OPO resonator and wherein the output wavelengths and their separation are configurable by using wavelength dependent feedback circuit components to create the OPO resonator.

10. The device of claim 9, wherein the wavelength dependent feedback is achieved by configuring the OPO resonator as a linear OPO resonator with Bragg mirrors having discrete reflectivity peaks.

11. The device of claim 9, wherein the wavelength dependent feedback is achieved by using grating assisted directional couplers in a racetrack OPO resonator.

12. The device of claim 9, wherein the wavelength dependent feedback is achieved using a micro-ring resonator inside the OPO resonator.

13. The device of claim 9, wherein the wavelength dependent feedback is achieved using one or more of Mach-Zehnder interferometers inside the OPO resonator.

14. The device of claim 9, wherein the wavelength dependent feedback is achieved using a wavelength demultiplexer combined with individual reflectors with different wavelengths.

15. The device of claim 14, wherein the OPO has separate optical parametric amplifiers (OPAs) for different output wavelengths pumped by a single laser or a plurality of lasers, and wherein the OPAs are combined with the multiplexer and individual reflectors wherein the output can be either a single spatial output or multiple spatial outputs.

16. The device of claim 1, wherein the device is configured so that the χ⁽²⁾ effect is an effective χ⁽²⁾ resulting from the intrinsic χ⁽²⁾ of the material, e.g. from applied electric field, photogalvanic effect, or photoconductive effect.

17. The device of claim 1, wherein the device is configured so that the multi-wavelength output is the result of formation of bright and/or dark solitons in the OPO.

18. A method for use with a photonic device, the method comprising generating several output wavelengths simultaneously in response to a single laser pump using a photonic integrated circuit with a χ⁽²⁾ optical parametric oscillator (OPO) on a chip, wherein the circuit is configurable to provide a desired uniform or non-uniform spacing of the output wavelengths.

19. The method of claim 18, further comprising modulating each of a plurality of individual wavelengths using a de-multiplexer to separate the individual wavelengths followed by processing by a bank of modulators configured to modulate each of the individual wavelengths.

20. A photonic device comprising a chip with a plurality of optical parametric oscillators (OPOs), each of which is configured to generate one or more wavelength channels, in response to one or more pump lasers, and wherein the one or more pump lasers are configured as a monolithic laser array or as a single laser followed by an N-way splitter on the chip.
